(19) United States
(12) Patent Application Publication
(10) Pub. No.: US 2015/0278381 A1
(43) Pub. Date: Oct. 1, 2015

(54) Systems and Methods for Storing and Accessing Historical Information Associated with Buildings

(71) Applicant: Lead Source Partners, Inc., Plano, TX (US)

(72) Inventor: Trevor Leeds, Costa Mesa, CA (US)

(21) Appl. No.: 14/673,092

(22) Filed: Mar. 30, 2015

Related U.S. Application Data
(60) Provisional application No. 61/972,131, filed on Mar. 28, 2014.

(51) Int. Cl. G06F 17/30

(52) U.S. Cl. CPC G06F 17/30876; G06F 17/30879; G06F 17/30424

(57) ABSTRACT

Systems and methods are provided that permit retrieval of historical data associated with a particular dwelling or other structure by reading barcode, QR code, or RFID indicia associated with materials or appliances of the structure. Historical data include data related to construction and to subsequent maintenance, repair, and other alterations to the structure, and can be conveniently retrieved from a distant database using an inquiry engine with a user interface.

This application claims the benefit of priority to U.S. Provisional Application No. 61/972,131, filed Mar. 28, 2014. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention relates to accessible, computer-implemented data storage systems, particularly computer-implemented data storage systems for storage and distribution of historical data related to buildings and building components.

### BACKGROUND

The background description includes information that may be useful in understanding the present invention. It is not an admission that any of the information provided herein is prior art or relevant to the presently claimed invention, or that any publication specifically or implicitly referenced is prior art.

It is frequently necessary to obtain historical information (for example, date of construction, date and type of repairs and improvements, dates and details of replacements, etc.) related to a building or dwelling. Such information has a wide variety of uses, including accurate assessment of insurance costs, accurate projection of future repair and maintenance costs, and information regarding construction materials for emergency personnel. Currently, however, such historical information is generally in the form of records maintained by the property owner or occupant. Not only are such records frequently incomplete and out of date, they may not be accessible in many situations (for example, during or after a house fire).

Systems have been proposed that centralize information related to particular locations or structures in a computer database. For example, U.S. Pat. No. 7,072,665 (to Blumberg and Blumberg) describes a system that provides a database of descriptive information (i.e. floor plans, maps, text or voice description, local airports, local restaurants) related to a landmark or structure associated with a specific location. A user provides location specific information related to the structure (for example, a physical address, GPS coordinates) to query the database. Such a system, however, does not provide maintenance, repair, and replacement information, and the location information utilized (for example, GPS) may not be sufficiently precise to identify a specific dwelling.

U.S. Patent Application Publication No. 2007/0033108 (to Luhr) describes a system in which a product identifier code is linked to products installed during building construction in addition to a tag that is attached to a building during its construction and that provides an identifier code that is unique to the property. These two identifiers provide information that allows a user to connect to a database that includes information regarding the initial construction of the building and the products utilized to do so. Such a system, however, does not accommodate information related to replacement items or repairs to existing items, and may be difficult to implement after initial construction.

U.S. Patent Application Publication No. 2012/0239581 (to Mosher) describes a system in which information related to various original and replacement building products (for example, warranty information, maintenance schedules, service providers) utilized in common during the construction of a large scale, multi-unit building project (for example, housing projects, apartment buildings, condominium complexes) is stored in a database. Subscribers can access the stored information, which can also include additional information (for example, service provider ratings, suggested replacement items). Such a system, however, does not accommodate the inevitable differences that will accrue between individual units and their contents as these projects age and components are repaired and replaced.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for a system that can conveniently store, in a user-retrievable manner, historical information related to a specific structure or dwelling.

### SUMMARY OF THE INVENTION

The inventive subject matter provides apparatus, systems and methods in which historical information for a specific structure is provided utilizing machine-readable indicia associated with or coupled to the structure. Historical information thus obtained includes data related to construction of the structure and data related to maintenance and repair of the structure.

In some embodiments of the inventive concept, a system is provided that includes machine readable indicia (for example, alphanumeric characters, a bar code, a QSR code, or an RFID) are included on a material or appliance that is coupled to the structure. The machine readable indicia encode or include location-specific information. The system also includes a reader that can scan or otherwise interrogate the machine-readable indicia to obtain a structure specification, which is subsequently transmitted to a processor that is in communication with a database of historical information related to the structure. The database stores information in a memory device (for example, volatile or non-volatile memory). In some embodiments, the database is in a different physical location from the structure. Historical information stored in the database includes information related to material, appliance, and labor warranties, repairs, and replacement of components of the structure. In some embodiments, the historical information includes a product identifier for the material or appliance that the indicia is associated with (for example, a roofing material). Suitable readers include a digital camera, portable telephone, smart telephone, tablet computer, smart watch, wearable computer, personal digital assistant, and/or an RFID reader. In some embodiments, the system includes an inquiry engine that runs on the processor, and which can provide a user interface. In such embodiments the inquiry engine can be a subscription service,

Another embodiment of the inventive concept is a method for providing historical information that is related to a specific structure or dwelling. In such methods a machine-readable indicia (for example, a string of alpha-numeric characters, bar code. QR code, or RFID) is provided that is associated with a material or appliance of the structure (for example, roofing material). Such a material or appliance can be associated with (for example attached to) the structure, or can be separated from the structure (for example, a tile or shingle separated from a damaged roof). Such indicia includes location specific information. The location specific information is read or otherwise obtained from the indicia and provided to an inquiry engine. The inquiry engine has user interface, and includes a processor that is in communication with a database. The inquiry engine is used to interrogate the database and retrieve requested historical information, which can be stored temporarily in a memory device (for example, volatile or non-volatile memory) of the database. The retrieved historical information is then transferred to the user via the user interface. The user interface can be implemented on any suitable platform, such as a terminal, personal computer, digital camera, portable telephone, smart telephone, smart watch, wearable computer, tablet computer, or personal digital assistant, and permits a user to select all or only part of the stored information related to the structure. In some embodiments, all or part of the inquiry engine is in the form of a subscription serves accessible via an information network.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A-1C schematically depict embodiments of the invention in which a roofing shingle includes indicia in the form of a bar code (FIG. 1A), a QR code (FIG. 1B), and an RFID (FIG. 1C).

FIG. 2 schematically depicts a system of the inventive concept in which information from indicia associated with a dwelling or other structure is used to access historical information related to the dwelling or other structure and stored in a database.

### DETAILED DESCRIPTION

The inventive subject matter provides apparatus, systems and methods in which a machine readable indicia is associated with a roofing material and/or other appliance or fixture that is substantially integrated into a dwelling or other structure. Reading of the indicia provides a unique identifier related to the structure that permits a user to interrogate a database containing historical information related to the specific structure.

Various objects, features, aspects and advantages of the inventive subject matter will become more apparent from the following detailed description of preferred embodiments, along with the accompanying drawing figures in which like numerals represent like components.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer should be read to include any suitable combination of computing devices, including desktop computers, portable computing devices, portable telephones, smart phones, smart watches, tablet computers, personal digital assistants, wearable computing devices, servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. Such data exchange or communication can be performed over a wired connection and/or a wireless connection (for example Bluetooth, WiFi)

One should appreciate that the disclosed techniques provide many advantageous technical effects including providing a simple and accurate means of identifying a specific structure, regardless of its age or status and providing a user with accurate historical information related to the structure.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In embodiments of the inventive concept, an identifier or “stamp” is provided that uniquely identifies a structure or dwelling and hence the materials and/or appliances utilized in construction, repair, and/or component replacement of such a structures and/or dwellings. The identifier or stamp can then be used to access information specific to the materials and/or contents of the structure or dwelling. A stamp or identifier of the inventive concept can be associated with, coupled to, and/or incorporated into materials or appliances of the dwelling or structure. Such materials and/or appliances are preferably associated with or coupled to the structure for an extended period of time, for example for the life of the structure or at least greater than 5 years. Suitable materials include roofing tiles, roofing shingles, roofing underlayments, bricks, stones, panels used for siding, and panels used for facades. Suitable appliances include water heaters, air conditioners, evaporative coolers, furnaces, air filtration units, photovoltaic panels, electrical power meters, gas meters, water meters, windows and/or skylights, appliances (for example dishwashers, dryers, ovens, ranges, waste disposers, and/or trash compactors), floor coverings (for example carpeting, tile, linoleum, and/or wood), alarm systems (for example, security alarms, fire/smoke detectors, carbon monoxide detectors, and/or radon detectors), or any component or appliance that is non-transiently associated with the structure or dwelling. In some embodiments, two or more components of a structure or dwelling can carry suitable identifiers, any one of which can be utilized to identify the structure or dwelling., fireplace installations, pool or spa heaters, and/or pool or spa filters. In some embodiments, material carrying the identifier can be a dedicated plaque, shingle, or similar artifact that is coupled to the structure at a readily identifiable and accessible location, for example under an eave or on an outside wall near an electrical, gas, or water meter.

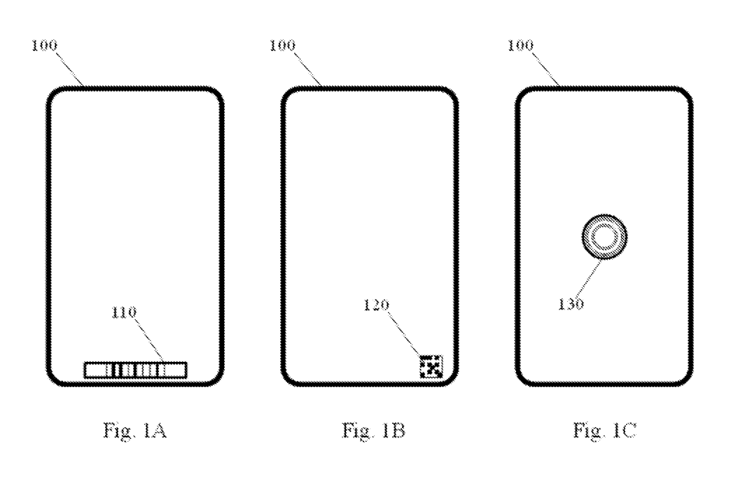

Identifiers or stamps of the inventive concept can be any suitable indicia that can be encoded to designate a specific dwelling or structure. In some embodiments, indicia can be both human and machine readable. Examples of a roofing shingle carrying such indicia are shown in FIGS. 1A, 1B, and 1C. In FIG. 1A, a shingle 100 includes a bar code 110. In FIG. 1B a shingle 100 includes a QR code. In FIG. 1C, the shingle 100 includes an RFID 130. In some embodiments indicia can include text or a string of alpha-numeric characters, which can in turn be identified visually and entered manually (for example, using a keyboard) or by using an imaging system in combination with character recognition software. In other embodiments indicia are machine readable. In such machine readable embodiments indicia can be include visible or non-visible (for example, infrared or ultraviolet reflecting) representations that are documentable by imaging systems. Examples of such indicia include one dimensional bar codes, two dimensional bar codes, QR codes, and images that can be processed and recognized (such as clickable paper). In still other embodiments, indicia can be imbedded or otherwise not externally observable, but incorporate a transmitting function readable using suitable equipment. Examples of such indicia include active RFID devices, passive RFID devices, iButton® devices, near field communication devices, and/or iBeacon® devices. Information can be gathered from such devices using suitable receiving equipment, such as a dedicated reader or a smart phone equipped with compatible hardware and/or applications.

Information related to materials and/or appliances and the structure with which they are associated can be stored as one or more records in a database, from which it can be accessed via a user interface. Such a record can be entered during initial construction and installation. Alternatively, such records can be entered following initial construction and installation. In preferred embodiments of the inventive concept information entered into the database and keyed to the stamp is both entered during initial construction/installation and is updatable, thereby providing a current historical record for the structure or dwelling, its materials, and/or its contents. For example, during initial construction the date of construction, construction company and contractors used, records relevant to materials (for example roofing, siding, and plumbing materials), and so on can be entered into the database and associated with the stamp. Alternatively, such records can be entered following initial construction, for example at such a time when a material or appliance that incorporates an identifier or stamp is utilized during a repair or otherwise associated with the dwelling or structure (for example, use of a roofing material that includes an identifier during a roof repair or replacement). Other information, for example records related to repair or replacement of dwelling or structure components, can be entered into the database following initial construction and associated with a stamp that is already associated with the dwelling or structure.

Information that is entered into the database can include any information that is likely to be of use to the occupant or owner of the structure that includes the stamp, and can include information that is useful to emergency or civil personnel that interact with the structure on an emergency basis. For example, such information can include purchase and/or installation dates, manufacturers, vendors, model numbers, warranty information (which is frequently transferrable), and/or properties (for example, fire resistance) for appliances, environmental controls, and/or materials (for example, roofing materials) associated with the dwelling or structure. Currently such records are maintained, often in paper form, by the purchaser and are often only partially transferred to new owners. Such paper records are also easily damaged in cases of flood or fire.

Information regarding the nature of the installation history of appliances, environmental controls, and/or materials of a dwelling or structure can also be entered to the database. Such an installation history can include the date of installation, contractor name and/or license number, preparative work performed prior to the installation (for example, removal or lack of removal of pre-existing roofing), materials used for installation (for example, use of copper or PVC piping), and information related to installation warranties. For example, new roofing materials can be installed after removal of old roofing material or, in some instances, applied over older and potentially flammable roofing material. Similarly, replacement of climate control equipment may retain components of the previous system (such as ductwork or coolant transfer lines). Along the same lines, in some instances historical information can record that partial replacements have been performed, for example replacement of a portion of the water feed lines to a structure.

A user wishing to access such a database to retrieve a historical record can do so by interrogating the material or appliance carrying the identifier so as to acquire data that identifies the structure or dwelling. Such data can, in some embodiments, also identify the material or appliance. Indicia can be read by any suitable means. In some embodiments a user can utilize a camera incorporated into a personal computing device (for example, a smart phone) to acquire an image of visible indicia. Such an image can be decoded locally (for example, using an app installed on the smart phone) and the decoded information utilized to access a database, or the image may be provided to an intermediate computing device (for example, a personal computer or a server) for decoding. In other embodiments, a device such as an RFID reader or near-field communication device can be used to acquire information from transmitting indicia. It should be appreciated that such an embodiment is particularly convenient for emergency personnel, such as firefighters, that may not be working under conditions that provide good visibility.

Once information from an identifier is acquired, a user can utilize such data to query a database for historical information related to the structure or dwelling. In a preferred embodiment, such a database is located at a location distant from the structure or dwelling, such that it is relatively unaffected by circumstances at or near the dwelling. In such an embodiment, a user can query the database from a terminal, personal computer, or portable computing device (for example a smart phone) via a user interface that provides communication with an information network. Such an information network can be accessed using a wired connection, a wireless connection, or a combination of these.

A processor that is in communication with the database and the information network can be configured to utilize the information from the identifier to access historical information stored in the database that is related to the structure or dwelling associated with the identifier. The processor can be additionally configured to provide all or part of this historical information to the user through the information network via the user interface. Towards this end the processor can include or be in communication with a memory storage device comprising an instruction set utilized to configure the processor. Such a memory storage device (or a different memory device that is also in communication with the processor) can be utilized to transiently store all or part of the historical information. In some embodiments of the inventive concept the memory device is a non-volatile memory device (for example, a hard drive, read-only memory, flash memory, ferroelectric RAM (F-RAM), floppy disks, magnetic tape, and/or optical discs). In other embodiments the memory device is a volatile memory device (for example, SRAM and/or DRAM).

In some embodiments of the inventive concept all or part of the process of accessing the database and retrieving and presenting the information can be implemented by an inquiry engine. The inquiry engine can include a user interface, a memory device that includes an instruction set for the inquiry engine, and a processor that is in communication with the memory device. The inquiry engine can be essentially wholly embodied in computing device that is directly accessed by the user (for example, a personal computer or smart phone), or can be embodied in components that are distributed across a computing device that is directly accessed by the user and other components that are accessed via an information network. In a preferred embodiment, all or part of the inquiry engine is implemented as a subscription service that can be accessed via an information network.

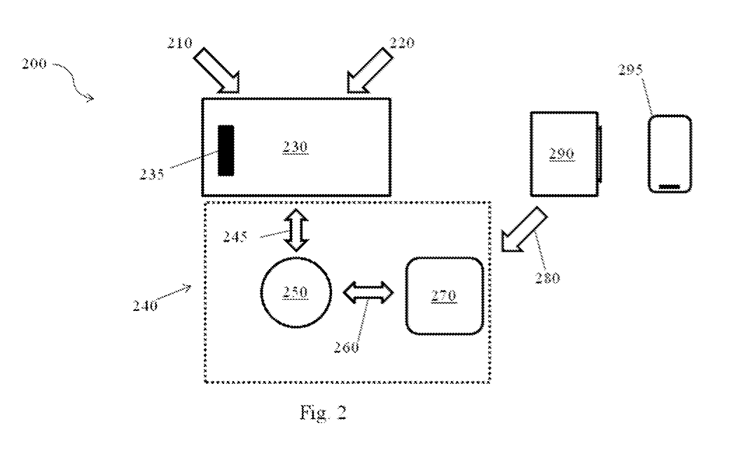

An example of a system of the inventive concept is depicted schematically in FIG. 2. In FIG. 2 the system 200 includes a database 230, which receives and stores information related to the specific structure gathered both during construction and initial installation 210 and during maintenance, repair, and component/appliance replacement 220. Towards that end, the database 230 can include a memory unit or device 235, which can include volatile and/or nonvolatile memory. In use, indicia provided on a material or appliance 295 associated with or coupled to the specific dwelling or other structure is read using a reader 290. Data from the indicia is transferred 280 to an inquiry engine 240. The inquiry engine 240 includes a user interface 270, through which a user can provide instructions and receive information 260. The inquiry engine can also include a processor 250, which supports the user interface 270. Such an inquiry engine can be realized as a standalone device, or can be in the form of a program or app running on a non-dedicated device (for example, as an app running on a smart phone). In some embodiments, the inquiry engine is a subscription service. In other embodiments, the inquiry engine has a subscription service component and supports limited functionality in the absence of a subscription.

The inquiry engine 240 is (via the processor 250) in communication 245 with the database, and can be used to identify and retrieve information to a user as directed via the user interface 270. Communication 245 between the inquiry engine 240 and the database 230 is preferably through a wireless technology, such as Bluetooth®, WiFi, or cellular communication. This provides convenience and permits the database 230 to be located at a distance from the specific structure or dwelling. This distance is advantageous, in that it serves to protect the database 230 (and therefore the information stored therein) from local conditions that are adverse to the specific structure, such as severe weather, earthquakes, and industrial accidents.

In an example of an embodiment of a system of the inventive concept, a prospective buyer can use their smart phone to acquire a digital image of a QR code located on an air conditioning unit installed in a home that they are interested in purchasing. An app on the smart phone can decode the QR code to provide an alphanumeric string. The prospective buyer can log in to a web service that provides a user interface that permits the prospective buyer to interrogate a database that includes historical information related to homes in the area via an information network. Alternatively, the app could provide such a user interface and a wireless connection to the information network. On entering the alphanumeric string the prospective buyer is presented with a menu of available information, and can quickly determine the year that the home was built, when the air conditioning unit was installed, model information on the air conditioning unit, what major household features or appliances have been replaced, and so on.

In another example of an embodiment of the inventive concept, a firefighter on the roof of a structure can use an RFID reader to interrogate an RFID indicia imbedded or otherwise associated with the structure's roofing material. Information provided by the RFID allows the firefighter to access historical information that lets the firefighter know that the roofing material is fire resistant, but was placed directly over older, flammable roofing material during installation. The firefighter can then take appropriate precautions that address the potential for a fire occurring beneath the visible roofing material.

It is also contemplated that in some circumstances a user can query indicia of materials that have been separated or displaced from the structures on which they have been installed. For example, in instances of earthquake or extreme weather a user (for example, an insurance adjustor) can query indicia of displaced roofing or other structural materials to determine if they originated from an insured's home.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for providing historical information related to a specific structure, comprising:
a machine-readable indicia associated with a material or appliance that is coupled to the specific structure, wherein the machine-readable indicia comprises location specific information;
a processor that is communicatively coupled to a database; and
a reader configured to scan the machine-readable indicia and transmit a structure specification the processor,
wherein the database comprises historical information related to the specific structure.

2. The system of claim 1, wherein the indicia is selected from the group consisting of an RFID device, a string of alphanumerical characters, a one dimensional bar code, a two dimensional bar code, and a QR code.

3. The system of claim 1, wherein the reader is selected from the group consisting of a digital camera, a portable telephone, a smart telephone, a smart watch, a tablet computer, a personal digital assistant, a wearable computer, and an RFID reader.

4. The system of claim 1, wherein the database is in a different physical location from that of the specific structure.

5. The system of claim 1, wherein the historical information comprises a repair or replacement history.

6. The system of claim 1, wherein the historical information comprises warranty information.

7. The system of claim 1, wherein the historical information comprises a product identifier for the material or appliance with which the machine-readable indicia is associated.

8. The system of claim 1, wherein the material or appliance is a roofing material.

9. The system of claim 1, wherein the database comprises a volatile memory device.

10. The system of claim 1, wherein the database comprises a nonvolatile memory device.

11. The system of claim 1, further comprising an inquiry engine configured to run on the processor.

12. The system of claim 11, wherein the inquiry engine comprises a user interface.

13. The system of claim 11, wherein the inquiry engine is configured as a subscription service.

14. A method for providing historical information related to a specific structure, comprising:
providing a machine-readable indicia associated with a material or appliance that is associated with the specific structure, wherein the machine-readable indicia comprises location specific information;
reading the location specific information from the machine-readable indicia;
providing the location specific information to an inquiry engine, the inquiry engine comprising a user interface and a processor that is in communication with a database and with a memory device;
via the inquiry engine, interrogating the database for historical information related to the specific structure;
via the inquiry engine, retrieving all or part of the historical information related to the specific structure and transiently storing all or part of the retrieved historical information in the memory device; and,
via the inquiry engine, utilizing the processor to transfer the retrieved historical information to the user via the user interface.

15. The method of claim 14 wherein the user interface is implemented on a device selected from the group consisting of a terminal, a personal computer, a digital camera, a portable telephone, a smart telephone, a smart watch, a tablet computer, a personal digital assistant, a wearable computer.

16. The method of claim 14, wherein the machine-readable indicia is selected from the group consisting of an RFID device, a string of alphanumerical characters, a one dimensional bar code, a two dimensional bar code, and a QR code.

17. The method of claim 14, wherein the user interface is configured to allow a user to select a subset if the historical data related to the specific structure.

18. The method of claim 14, wherein the memory device is a volatile memory device.

19. The method of claim 14, wherein the memory device is a nonvolatile memory device.

20. The method of claim 14, wherein the material or appliance is affixed to the specific structure.

21. The method of claim 13, wherein the material or appliance is not affixed to the specific structure.

22. The method of claim 14, wherein the material or appliance is a roofing material.

23. The method of claim 14, wherein all or part of the inquiry engine is realized as a subscription service that is accessible via an information network.
